(19) United States
(12) Patent Application Publication
(10) Pub. No.: US 2025/0025786 A1
(43) Pub. Date: Jan. 23, 2025

(54) Social Methods And Systems Based on Three-Dimensional Virtual Environments

(71) Applicant: Tencent Technology (Shenzhen) Company Limited, Shenzhen (CN)

(72) Inventors: Chenghao Ye, Shenzhen (CN); Ziyi Wang, Shenzhen (CN); Boyi Liu, Shenzhen (CN); Jieqi Xie, Shenzhen (CN); Cong Tian, Shenzhen (CN); Weijian Cui, Shenzhen (CN); Zhi Li, Shenzhen (CN)

(21) Appl. No.: 18/888,252

(22) Filed: Sep. 18, 2024

Related U.S. Application Data
(63) Continuation of application No. PCT/CN2023/124751, filed on Oct. 16, 2023.

(30) Foreign Application Priority Data
Nov. 17, 2022 (CN) 202211440883.9

(51) Int. Cl. A63F 13/5372; A63F 13/52; A63F 13/5375; A63F 13/69; A63F 13/87

(52) U.S. Cl. CPC A63F 13/5372; A63F 13/52; A63F 13/5375; A63F 13/69; A63F 13/87

(57) ABSTRACT

This application discloses a social method and apparatus based on a three-dimensional virtual environment, a device, and a medium, and belongs to the field of virtual environments. The method includes: displaying a first virtual character located at a first position in a three-dimensional virtual environment; receiving a check-in operation, the check-in operation including an operation of editing first social information for a first event; and displaying a first check-in marker created by the first virtual character at a second position in the three-dimensional virtual environment, the first check-in marker being configured for displaying, to a virtual character arriving at the second position, the first social information edited by the first virtual character for the first event. In the foregoing solution, a check-in marker may be placed in the three-dimensional virtual environment to share social information with another virtual character in the three-dimensional virtual environment.

### RELATED APPLICATION

This application is a continuation application of PCT Application PCT/CN2023/124751, filed Oct. 16, 2023, which claims priority to Chinese Patent Application No. 202211440883.9, filed on Nov. 17, 2022, each entitled “SOCIAL METHOD AND APPARATUS BASED ON THREE-DIMENSIONAL VIRTUAL ENVIRONMENT, DEVICE, AND MEDIUM”, and each which is incorporated herein by reference in its entirety.

### FIELD OF THE TECHNOLOGY

This application relates to the field of human-computer interaction, and in particular, to a social method and apparatus based on a three-dimensional virtual environment, a device, and a medium.

### BACKGROUND

In a battle arena shooting game, a plurality of game sharing modes may be provided, so that a player can share game insights to another player.

The player may take a screenshot in a game battle to capture a game picture. Through a social program, a game forum, or the like, the player may display the screenshot and describe relevant insights, to share the game insights with another player.

The game insights can only be shared to another player outside of the game battle.

### SUMMARY

This disclosure provides a method, an apparatus, a device, and a medium for a three-dimensional virtual environment. A check-in marker may be placed in the three-dimensional virtual environment to share social information with another virtual character in the three-dimensional virtual environment. The technical solutions are as follows:

According to an aspect, a social method based on a three-dimensional virtual environment is provided. The method is performed by a computer device, and the method includes:
displaying a first virtual character located at a first position in a three-dimensional virtual environment;
receiving a check-in operation, the check-in operation including an operation of editing first social information for a first event; and
displaying a first check-in marker created by the first virtual character at a second position in the three-dimensional virtual environment, the first check-in marker being configured for displaying, to a virtual character arriving at the second position, the first social information edited by the first virtual character for the first event.

According to another aspect, a social apparatus based on a three-dimensional virtual environment is provided. The apparatus includes:
a display module, configured to display a first virtual character located at a first position in a three-dimensional virtual environment; and
an interaction module, configured to receive a check-in operation, the check-in operation including an operation of editing first social information for a first event; and
the display module being configured to display a first check-in marker created by the first virtual character at a second position in the three-dimensional virtual environment, and the first check-in marker being configured for displaying, to a virtual character arriving at the second position, the first social information edited by the first virtual character for the first event.

According to an aspect, a computer device is provided. The computer device includes: a processor and a memory, the memory having a computer program stored therein, and the computer program being loaded and executed by the processor to implement the social method based on the three-dimensional virtual environment as described above.

According to another aspect, a computer-readable storage medium is provided, the storage medium having a computer program stored therein, and the computer program being loaded and executed by a processor to implement the social method based on the three-dimensional virtual environment as described above.

According to another aspect, a computer program product is provided, the computer program product including computer instructions, and the computer instructions being stored in a computer-readable storage medium. A processor of a computer device reads the computer instructions from the computer-readable storage medium, and the processor executes the computer instructions, to enable the computer device to perform the social method based on the three-dimensional virtual environment according to the foregoing aspects.

When a check-in operation is received, a check-in marker may be placed in a three-dimensional virtual environment based on a current position of a main virtual character, the check-in marker recording social information posted by the main virtual character for a first event. When another virtual character in the three-dimensional virtual environment approaches the check-in marker, the check-in marker may display, to the another virtual character, the social information posted by the main virtual character, so that the social information may be shared with the another virtual character in a battle. In this way, when the main control virtual character triggers an event at a position in the three-dimensional virtual environment, or when the main control virtual character discovers a colored egg at a position in the three-dimensional virtual environment, the main control virtual character may set a check-in marker at the position, and share an achievement or a discovery to another virtual character arriving at the position. The another virtual character may view social information on the check-in marker, and at the same time, the another virtual character may also view a surrounding environment of the check-in marker and personally experience the event described in the social information.

In addition, each virtual character arriving at the position can view the social information, and there may be no need for the main virtual character to send the social information to each virtual character one by one. This helps simplify a social information sharing procedure and reduces processing resource consumption in a social information sharing process.

### BRIEF DESCRIPTION OF THE DRAWINGS

FIG. 1 is a block diagram of a structure of a computer system according to an illustrative aspect.

FIG. 2 is a flowchart of a social method based on a three-dimensional virtual environment according to an illustrative aspect.

FIG. 3 is a flowchart of a social method based on a three-dimensional virtual environment according to an illustrative aspect.

FIG. 4 is a schematic diagram of a social method based on a three-dimensional virtual environment according to an illustrative aspect.

FIG. 5 is a schematic diagram of a social method based on a three-dimensional virtual environment according to an illustrative aspect.

FIG. 6 is a schematic diagram of a social method based on a three-dimensional virtual environment according to an illustrative aspect.

FIG. 7 is a schematic diagram of a social method based on a three-dimensional virtual environment according to an illustrative aspect.

FIG. 8 is a schematic diagram of a social method based on a three-dimensional virtual environment according to an illustrative aspect.

FIG. 9 is a flowchart of a social method based on a three-dimensional virtual environment according to an illustrative aspect.

FIG. 10 is a schematic diagram of a social method based on a three-dimensional virtual environment according to an illustrative aspect.

FIG. 11 is a schematic diagram of a social method based on a three-dimensional virtual environment according to an illustrative aspect.

FIG. 12 is a schematic diagram of a social method based on a three-dimensional virtual environment according to an illustrative aspect.

FIG. 13 is a schematic diagram of a social method based on a three-dimensional virtual environment according to an illustrative aspect.

FIG. 14 is a flowchart of a social method based on a three-dimensional virtual environment according to an illustrative aspect.

FIG. 15 is a schematic diagram of a social method based on a three-dimensional virtual environment according to an illustrative aspect.

FIG. 16 is a flowchart of a social method based on a three-dimensional virtual environment according to an illustrative aspect.

FIG. 17 is a schematic diagram of a social method based on a three-dimensional virtual environment according to an illustrative aspect.

FIG. 18 is a flowchart of a social method based on a three-dimensional virtual environment according to an illustrative aspect.

FIG. 19 is a block diagram of a structure of a social apparatus based on a three-dimensional virtual environment according to an illustrative aspect.

FIG. 20 is a block diagram of a structure of a computer device according to an illustrative aspect.

### DETAILED DESCRIPTION

Illustrative aspects are described in detail herein, and examples of the illustrative aspects are shown in the accompanying drawings. When the following description involves the accompanying drawings, unless otherwise indicated, the same numerals in different accompanying drawings represent the same or similar elements. The implementations described in the following illustrative aspects do not represent all implementations. On the contrary, the implementations are merely examples of apparatuses and methods that are described in detail in the appended claims and that are consistent with some aspects.

“Several” mentioned in the specification means one or more, and “plurality of” means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

First, terms involved in aspects are briefly introduced.

Three-dimensional virtual environment (or referred to as “virtual environment”): The three-dimensional virtual environment may be a virtual environment displayed (or provided) when a client may be run on a terminal. The virtual environment may be a simulated environment of the real world, or may be a semi-simulated and semi-fictional environment, or may be an entirely fictional environment.

In some aspects, the virtual environment may be a battle environment of a virtual character. For example, in a survival-type game, at least one virtual character may perform a single battle in the virtual environment. The virtual character may achieve an objective of surviving in the virtual environment by avoiding an attack initiated by an enemy unit and a danger (for example, a poison gas zone and a swamp) present in the virtual environment. When a health point of the virtual character in the virtual environment is zero, a life of the virtual character in the virtual environment may end, and the last surviving virtual character may be a winner.

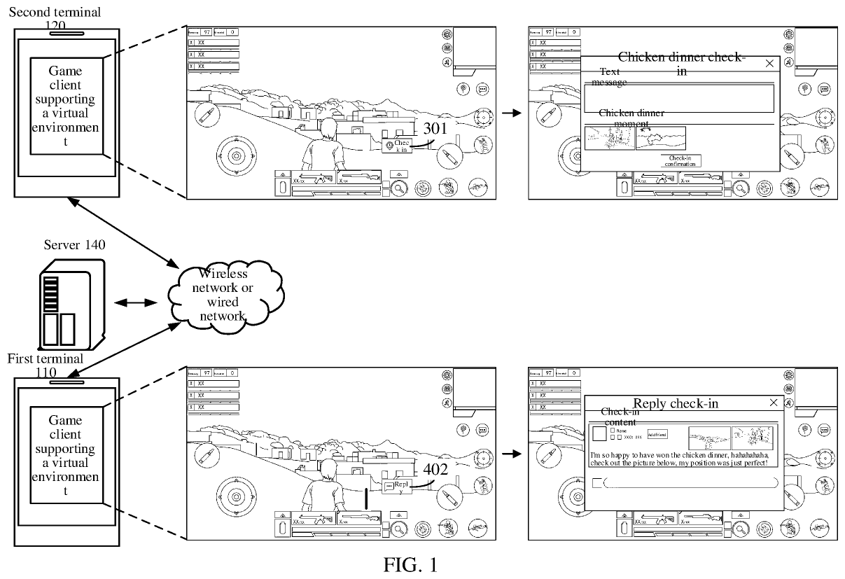

FIG. 1 may be a block diagram of a structure of a computer system according to an illustrative aspect. The computer system may include: a first terminal 110, a second terminal 120, and a server 140.

A client supporting a virtual environment may be installed and run on the first terminal 110. A control account of a main virtual character may log in to the client, and the client may be any one of a three-dimensional map program, a first-person shooting (FPS) game, a third-person shooting (TPS) game, a multiplayer online battle arena (MOBA) game, a role-playing game (RPG), a virtual reality (VR) application program, or an augmented reality (AR) program. The first terminal 110 may be a terminal used by a first user. The first user may use the first terminal 110 to control a first virtual character located in the virtual environment to perform an activity. The activity may include but is not limited to at least one of adjusting a body posture, walking, running, jumping, riding, driving, aiming, picking, or using a throwing item. For example, the first virtual character may be a virtual person, such as a simulated person object or a cartoon person object. For example, the first user controls the first virtual character to perform the activity through a UI control on a virtual environment picture.

A client supporting a virtual environment may be installed and run on the second terminal 120. A control account of a main virtual character logs in to the client, and the client may be any one of a three-dimensional map program, a first-person shooting game, a third-person shooting game, a MOBA game, a role-playing game, a virtual reality application program, and an augmented reality program. The second terminal 120 may be a terminal used by a second user. The second user may use the second terminal 120 to control a second virtual character located in the three-dimensional virtual environment to perform an activity. The activity may include but is not limited to at least one of adjusting a body posture, walking, running, jumping, riding, driving, aiming, picking, or using a throwing item. For example, the second virtual character may be a virtual person, such as a simulated person object or a cartoon person object. For example, the second user may control the second virtual character to perform the activity through a UI control on a virtual environment picture.

The first terminal 110 and the second terminal 120 may be connected to the server 140 through a wireless network or a wired network.

The server 140 may include at least one of one server, a plurality of servers, a cloud computing platform, or a virtualization center. For example, the server 140 may include a processor and a memory, and the memory may include a receiving module, a control module, and a sending module. The receiving module may be configured to receive a request sent by the client, for example, a request for controlling movement of the virtual character. The control module may be configured to control rendering of the virtual environment picture. The sending module may be configured to send a response to the client, for example, send, to the client, information indicating that a position of the virtual character has changed. The server 140 may be configured to provide a backend service for the client supporting the virtual environment. In some aspects, the server 140 may be responsible for primary computing work, and the first terminal 110 may be responsible for secondary computing work. Alternatively, the server 140 may be responsible for secondary computing work, and the first terminal 110 may be responsible for primary computing work. Alternatively, the server 140 and the first terminal 110 are responsible for computing work in a coordinated manner.

An example in which a game client that supports the virtual environment and that may be run on the first terminal and the second terminal may be a shooting game client may be used for description. The second user may control the second virtual character through the second terminal to create a second check-in marker in the three-dimensional virtual environment. For example, the second user may trigger a check-in control 301 to open a “chicken dinner check-in” interface, edit second social information, and perform “check-in confirmation” on the “chicken dinner check-in” interface, so that the second check-in marker may be displayed in the three-dimensional virtual environment.

The first user may control the first virtual character through the first terminal to approach the second check-in marker in the three-dimensional virtual environment, and tap/click a reply control 402 of the second check-in marker to display a “reply check-in” interface. The second social information edited by the second user may be displayed on the “reply check-in” interface. The first user may edit and send reply information by triggering a text box on the “reply check-in” interface.

In some aspects, the client may be run on different operating system platforms (Android or IOS). In some aspects, a device type of the terminal may include: at least one of a smartphone, a smart watch, a vehicle-mounted terminal, a wearable device, a smart television, a tablet computer, an e-book reader, an MP3 player, an MP4 player, a laptop portable computer, or a desktop computer. An example in which the terminal includes the smartphone may be used for description in the following aspects.

A person skilled in the art may learn that there may be more or fewer terminals. For example, there may be only one terminal, or there may be dozens or hundreds of terminals, or more terminals. The quantity and the device type of the terminals are not limited in aspects.

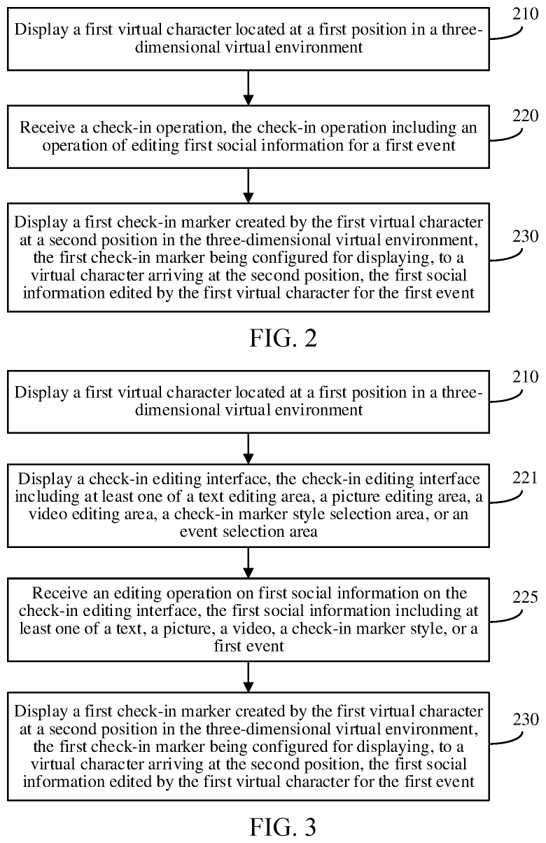

FIG. 2 is a flowchart of a social method based on a three-dimensional virtual environment according to an illustrative aspect. An example in which the method may be applied to the terminal (or the client that supports the three-dimensional virtual environment and that may be installed on the terminal) shown in FIG. 1 may be used for description. The method includes the following operations.

Operation 210: Display a first virtual character located at a first position in a three-dimensional virtual environment.

The first virtual character may be a virtual character controlled by the terminal (the client on the terminal) that performs the method, namely, a main virtual character.

Virtual character: The virtual character may refer to a movable object controlled by the client in a virtual environment. The movable object may be a virtual person, a virtual animal, a cartoon person, or the like, for example, a person or an animal displayed in the three-dimensional virtual environment. In some aspects, the virtual character may be a three-dimensional model created based on an animated skeletal technology. Each virtual character may have a shape and a volume in the three-dimensional virtual environment, and occupy a part of space in the three-dimensional virtual environment. In some aspects, a virtual character (for example, a second virtual character) other than the first virtual character may be a virtual character controlled by another client, or may be a virtual character controlled by a server/computer program/artificial intelligence, for example, a human-computer virtual character.

In some aspects, the three-dimensional virtual environment may be a three-dimensional virtual environment of a game battle. For example, the three-dimensional virtual environment may be a three-dimensional virtual environment of a first map of the game battle, and the first virtual character engages in the game battle in the first map. The three-dimensional virtual environment may be a three-dimensional virtual environment of a game battle supporting the three-dimensional virtual environment. For example, the three-dimensional virtual environment may be a three-dimensional virtual environment of a game battle of a battle arena shooting game/a first-person shooting game/a third-person shooting game/a MOBA game.

The three-dimensional virtual environment may alternatively be a three-dimensional virtual environment outside of the game battle. For example, the three-dimensional virtual environment may be a three-dimensional virtual environment of a main scene of a game. For example, the three-dimensional virtual environment may be a three-dimensional virtual environment of a role-playing game (RPG).

The first position may be a position point in the three-dimensional virtual environment. In some aspects, the first position may be located on a ground in the three-dimensional virtual environment. The ground may refer to any model surface on which the first virtual character can stand, including a building surface, a terrain surface, a virtual vehicle surface, and the like. In some aspects, the first position may include three-dimensional coordinates, or the first position includes two-dimensional coordinates on a horizontal plane in the three-dimensional virtual environment.

The first position may be a position at which the first virtual character may be currently located. Alternatively, the first position may be a position at which the first virtual character triggers a first event. Alternatively, the first position may be a position at which the first virtual character may be located when a check-in operation may be triggered.

In some aspects, a battle picture in which the first virtual character engages in the game battle in the first map may be displayed, and the battle picture may include the first virtual character located at the first position in the three-dimensional virtual environment of the first map. In some aspects, the battle picture may be a picture of the three-dimensional virtual environment obtained with the first virtual character as an observation target. That is, the first virtual character may be located at a center position of the battle picture.

Operation 220: Receive the check-in operation, the check-in operation including an operation of editing first social information for the first event.

The check-in operation may be an operation triggered by a user. For example, the check-in operation may be: at least one of an operation of triggering a check-in control displayed on an interface, an operation of controlling the first virtual character to perform a check-in action, an operation of triggering a keyboard key corresponding to the check-in operation, a voice control instruction configured for triggering the check-in action, or an action control instruction configured for triggering the check-in action.

The first event may be a topic event for the first virtual character to check in. In other words, when social sharing needs to be performed for the first event, the check-in operation may be triggered.

The first event may be an event triggered by the first virtual character, and the check-in control may be displayed on the interface after the first event is triggered, so that the first virtual character may check in for the first event. For example, the first event may be winning a game battle by the first virtual character, defeating another virtual character by the first virtual character, triggering a hidden storyline by the first virtual character, achieving an achievement by the first virtual character, or obtaining a virtual item first by the first virtual character.

Alternatively, the first event may be an event selected when the first virtual character checks in. For example, an event selection area may be provided on a check-in editing interface, and the user may select the first event in the event selection area as a topic event for checking in. For example, the first event may be a social topic event such as daily sharing, battle experience sharing, skin display, or friending.

In some aspects, a check-in marker provided may also be configured for triggering a special interaction between virtual characters, and the first event may alternatively be a special interaction event. For example, the user may select the special interaction event in the event selection area. For example, the special interaction event includes: prize quizzes, snatching red packets, selling a virtual item of the first virtual character, exchanging a target item with a virtual item of the first virtual character, summoning the first virtual character, and the like.

In some aspects, different first events may correspond to social information of different types.

The social information may include at least one type of information posted by the first virtual character through checking in. The social information may include: at least one of the first event, a text, a picture, a video, audio, a link, a check-in marker style, a three-dimensional model display, a question, an answer, a reward, related information of a red packet, a sold virtual item, a virtual item for exchange, or a virtual item intended to be obtained.

The text may be a text input by the user or a text automatically generated by a system. The picture may be a picture automatically taken by the system for the first event, a picture taken by the user in a game, or a picture uploaded from a local album. The video may be a video automatically recorded by the system for the first event, a video recorded by the user in the game, or a video uploaded from the local album. The audio may be audio recorded by the system for the first event, audio recorded by the user in the game, or audio uploaded locally. The link may be a jump link automatically generated by the system based on the first event or a jump link input by the user.

The three-dimensional model display may be configured for displaying a virtual model, such as the first virtual character, a user-selected skin, a virtual item, or a virtual vehicle. The three-dimensional model display may be further configured for reproducing a scene model (the first event may be continuously and cyclically played in the scene model) in which the first event occurs. By observing the three-dimensional model display, the user can view, from any angle, a complete process in which the first virtual character triggers the first event in the scene model. For example, a scene in which the first virtual character kills another virtual character may be reproduced. The three-dimensional model display may enable the user to observe the virtual model in the three-dimensional model display from a plurality of angles. For example, the user may rotate the virtual model in the three-dimensional model display and view the model from any angle. Alternatively, when the three-dimensional model display may be configured for reproducing the first event, the user may select different perspectives to view, for example, select a perspective of the first virtual character, or a perspective of another virtual character, or a spectator perspective, and view, from different perspectives, the first event cyclically displayed in the same scene model.

In an aspect, when the first event may be a battle winning event, the three-dimensional model display may be configured for displaying a process in which the last virtual character may be defeated.

Operation 230: Display a first check-in marker created by the first virtual character at a second position in the three-dimensional virtual environment, the first check-in marker being configured for displaying, to a virtual character arriving at the second position, the first social information edited by the first virtual character for the first event.

After receiving the check-in operation, a terminal device displays the first check-in marker at the second position in the three-dimensional virtual environment based on the first social information in the check-in operation.

In a possible implementation, the second position may be determined based on the first position. The first position may be the same as the second position. Alternatively, the second position may be located in a perspective direction of the first virtual character and may be at a fixed distance from the first position. Alternatively, the second position may be a position to which an aiming sight of the first virtual character points. Alternatively, the second position may be a position associated with the first position.

In some aspects, the first check-in marker may be fixed at the second position, and cannot be moved and cannot be picked up.

In some aspects, the second position of the first check-in marker may be permanently bound to the three-dimensional virtual environment for storage. The server permanently stores the first check-in marker located at the second position in the three-dimensional virtual environment. Stored data may be not cleared as a current battle ends. In addition, in a subsequent battle performed in the three-dimensional virtual environment, the data may be also loaded, and the first check-in marker may be displayed at the second position in the three-dimensional virtual environment. That is, after the first virtual character creates the first check-in marker, the first check-in marker may always exist in the three-dimensional virtual environment. Always existing may include: After the current battle ends, in a second battle performed in the three-dimensional virtual environment, the first check-in marker may also be seen at the second position, and the second battle may be a battle in which the first virtual character participates or a battle in which the first virtual character does not participate. Correspondingly, the first check-in marker may become a fixed scene model in the three-dimensional virtual environment.

Certainly, considering that an excessive quantity of check-in markers in the three-dimensional virtual environment affects movement of a virtual character in the three-dimensional virtual environment, data related to the check-in marker in the three-dimensional virtual environment may alternatively be periodically cleared. Alternatively, a total quantity of check-in markers in the three-dimensional virtual environment may be limited, and data of an earliest created check-in marker may be cleared in chronological order. Alternatively, check-in markers are classified, and some classified check-in markers are displayed according to the main control virtual character. Alternatively, when a check-in marker may be configured for performing the special interaction event, data of the check-in marker may be deleted after the special interaction event is completed. Alternatively, when a duration for which the check-in marker exists reaches a first time threshold and interaction hotness of a check-in marker is less than a hotness threshold, data of the check-in marker may be deleted. The interaction hotness may be determined based on a reply quantity/like quantity of the check-in marker. Therefore, a quantity of check-in markers in the three-dimensional virtual environment may be limited.

In some aspects, the first check-in marker may alternatively exist at the second position only in the current battle, and may be cleared after the battle ends. The first check-in marker does not appear at the second position in other battles.

In some aspects, the first check-in marker may be a three-dimensional virtual model displayed in the three-dimensional virtual environment. The first check-in marker may be displayed as a light beam, a statue, a treasure chest, a building, a plant, or the like.

In an optional aspect, the first check-in marker may be a transparent model (a transparent model through which a virtual character can pass, or a transparent model through which a virtual character cannot pass). To be specific, the user cannot see the first check-in marker in the three-dimensional virtual environment, but when the virtual character approaches the first check-in marker, a viewing control of the first check-in marker may be displayed, and by triggering the viewing control, the user may view the first social information on the first check-in marker. In this way, another virtual character may search for the first check-in marker in the three-dimensional virtual environment in a treasure hunt manner.

A display style of the first check-in marker may be default. In other words, different events all correspond to a check-in marker with a same style. Alternatively, a display style of the first check-in marker depends on the first event, and different events correspond to check-in markers with different styles. Alternatively, a display style of the first check-in marker may be selected by the user.

The first check-in marker may be configured for displaying the first social information to another virtual character nearby. For example, the virtual character arriving at the second position includes: a virtual character whose distance from the second position may be less than a threshold.

When the another virtual character approaches the first check-in marker, the first social information corresponding to the first check-in marker may be automatically displayed. Alternatively, when the another virtual character approaches the first check-in marker, the viewing control may be displayed on an interface. In response to receiving a triggering operation on the viewing control, a display interface may be displayed, and the first social information may be displayed on the display interface. Alternatively, when the first social information includes the three-dimensional model display, a picture of the three-dimensional model display may be displayed when the another virtual character approaches the first check-in marker. Alternatively, the another virtual character may be controlled to enter, from the three-dimensional virtual environment, the scene model in the three-dimensional model display, and the first event played in the scene model may be viewed from a perspective of the another virtual character.

In some aspects, a virtual character other than the first virtual character may be allowed to view the first social information on the first check-in marker, and the first virtual character may be not allowed to view the first social information. In other words, the first virtual character cannot view the first social information when approaching the first check-in marker. In other words, a publisher cannot view social information posted by the publisher, but can only view social information posted by others.

In some aspects, a virtual character belonging to a same camp as the first virtual character may be allowed to view the first social information on the first check-in marker, and a virtual character belonging to a camp different from a camp to which the first virtual character belongs cannot view the first social information.

In some aspects, the another virtual character may interact with the first check-in marker. The interaction may include: viewing, replying, liking, friend adding, obtaining rewards, exchanging items, purchasing items, and the like. In some aspects, an interaction manner may be determined based on an event type of the first event, or may be manually set by the user. For example, when the first event may be the battle winning event, a default interaction manner may include viewing, replying, liking, and friend adding. The user may alternatively customize the interaction manner as obtaining the rewards. To be specific, the second virtual character arriving at the first check-in marker may obtain a specific reward.

Based on the above, according to the method provided in this aspect, when a check-in operation may be received, a check-in marker may be placed in a three-dimensional virtual environment based on a current position of a main virtual character. The check-in marker may record social information posted by the main virtual character for a first event. When another virtual character in the three-dimensional virtual environment approaches the check-in marker, the check-in marker may display, to the another virtual character, the social information posted by the main virtual character, so that the social information may be shared with the another virtual character in a game battle. In this way, when the main control virtual character triggers an event at a position in the three-dimensional virtual environment, or when the main control virtual character discovers a colored egg at a position in the three-dimensional virtual environment, the main control virtual character may set a check-in marker at the position, and share an achievement or a discovery to another virtual character arriving at the position. The another virtual character may view social information on the check-in marker, and at the same time, the another virtual character may also view a surrounding environment of the check-in marker and personally experience the event described in the social information.

FIG. 3 is a flowchart of a social method based on a three-dimensional virtual environment according to an illustrative aspect. Based on the aspect shown in FIG. 2, operation 220 may include operation 221 and operation 225.

Operation 210: Display a first virtual character located at a first position in a three-dimensional virtual environment.

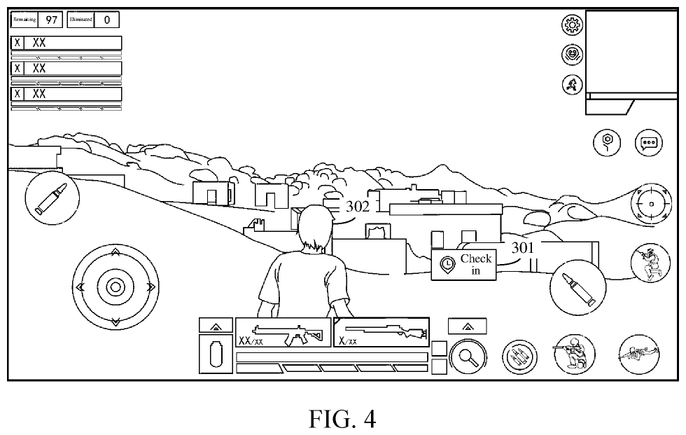

For example, as shown in FIG. 4, a user interface may be displayed. The user interface may include a battle picture and a check-in control 301. The battle picture includes a first virtual character 303 located at the first position in the three-dimensional virtual environment.

For example, when the first virtual character triggers a first event, a first to-be-checked-in marker may be displayed at a second position in the three-dimensional virtual environment. In response to the first virtual character approaching the first to-be-checked-in marker, a terminal may display a check-in control. In response to triggering the check-in control, operation 221 may be performed to display a check-in editing interface. In response to completing checking in, the terminal may replace the first to-be-checked-in marker with a first check-in marker and display the first check-in marker. Display states of the first to-be-checked-in marker and the first check-in marker may be different.

Operation 221: Display the check-in editing interface, the check-in editing interface including at least one of a text editing area, a picture editing area, a video editing area, a check-in marker style selection area, or an event selection area.

For example, in response to receiving an operation of triggering the check-in control, the terminal may display the check-in editing interface. Alternatively, in response to the first virtual character performing a check-in action, the terminal may display the check-in editing interface. Alternatively, in response to an operation of aiming at a second position to fire a check-in item, the terminal may display the check-in editing interface.

The check-in editing interface may be configured for editing social information, and first social information may include social information displayed on the check-in editing interface when checking in may be confirmed.

The check-in editing interface may include at least one of the text editing area, the picture editing area, the video editing area, the check-in marker style selection area, or the event selection area.

The text editing area may be configured for editing a text, and the picture editing area may be configured for taking a screenshot, uploading a picture, and editing a picture. The video editing area may be configured for recording a video, uploading a video, and editing a video. The check-in marker style selection area may be configured for selecting a check-in marker style. The event selection area may be configured for selecting an event or editing an event.

In some aspects, different events may correspond to different check-in editing interfaces. Correspondingly, the terminal displays a corresponding check-in editing interface based on the first event.

For example, when the first event may be that the first virtual character wins a battle, the check-in editing interface may include at least one of a text editing area, a picture editing area, a video editing area, or an audio editing area.

When the first event is skin display, the check-in editing interface may include at least one of a text editing area or a skin selection area.

When the first event is a prize quiz, the check-in editing interface may include at least one of a question editing area, an answer editing area, a reward selection area, a respondent constraint editing area, a text editing area, a picture editing area, a video editing area, or an audio editing area.

When the first event is sending a red packet, the check-in editing interface may include at least one of a red packet quantity editing area, a red packet amount editing area, a red packet sending rule selection area, a red packet collector limit condition editing area, a text editing area, a picture editing area, a video editing area, or an audio editing area.

When the first event is selling a virtual item, the check-in editing interface may include at least one of a virtual item selection area, a selling amount editing area, a text editing area, a picture editing area, a video editing area, an audio editing area, a starting price editing area, or an auction start time and end time editing area.

When the first event is exchanging virtual items, the check-in editing interface may include at least one of a virtual item selection area for exchange, a desired virtual item selection area, a text editing area, a picture editing area, a video editing area, or an audio editing area.

When the first event is summoning the first virtual character, the check-in editing interface may include at least one of a summon condition editing area, a first virtual character introduction editing area, a text editing area, a picture editing area, a video editing area, or an audio editing area.

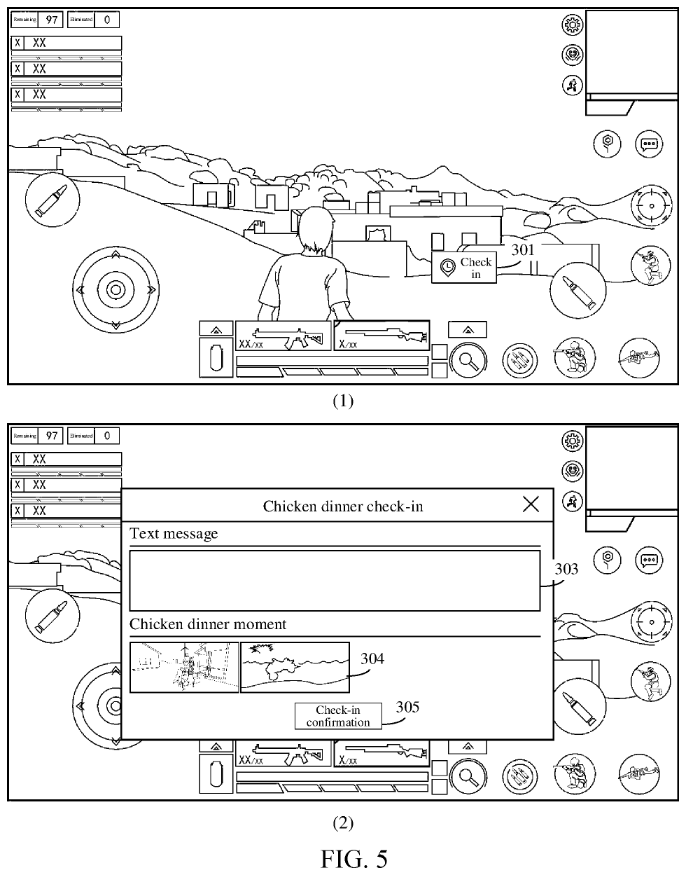

For example, as shown in (1) in FIG. 5, in response to receiving an operation of triggering the check-in control 301, a check-in editing interface shown in (2) in FIG. 5 may be displayed. The check-in editing interface may include a text editing area 303, a picture editing area 304, and a check-in confirmation control 305.

In some aspects, when the check-in editing interface includes the picture editing area, at least one picture automatically obtained for the first event may be displayed by default in the picture editing area.

In a possible implementation, when the first event is triggered, a terminal device/server can automatically obtain pictures related to the first event, and when a user opens the check-in editing interface, the pictures may be automatically displayed in the picture editing area, for the user to select or store.

In some aspects, in response to an operation of viewing one of the at least one picture, the terminal may enlarge and display the picture, and display a save-to-album control and a cancel control. In response to triggering the save-to-album control, the terminal may save the picture to a local album. In response to triggering the cancel control, the terminal may return to the check-in editing interface.

When the first event includes that the first virtual character wins a first battle, when a third virtual character is defeated causing the first virtual character to win the first battle, the at least one picture includes a picture, obtained from a perspective of the third virtual character, that the third virtual character may be defeated; and when a fourth virtual character defeats the third virtual character causing the first virtual character to win the first battle, the at least one picture includes a picture, obtained from the perspective of the third virtual character, that the third virtual character may be defeated, and a picture, obtained from a perspective of the fourth virtual character, that the fourth virtual character defeats the third virtual character. The first virtual character and the fourth virtual character are a same virtual character, or the first virtual character and the fourth virtual character are virtual characters of a same camp.

That is, when a battle ends, the terminal device/server automatically obtains pictures from perspectives of both sides in a final defeat. For example, if the first virtual character defeats the third virtual character, a defeat picture from a perspective of the first virtual character and a kill picture from the perspective of the third virtual character are obtained respectively, and the two pictures are displayed in the picture editing area of the check-in editing interface. Alternatively, if the fourth virtual character defeats the third virtual character, and the first virtual character may be a teammate of the fourth virtual character, a team to which the first virtual character belongs wins the battle, and the terminal device/server automatically obtains a defeat picture from the perspective of the fourth virtual character and a defeat picture from the perspective of the third virtual character, and displays the two pictures in the picture editing area of the check-in editing interface. Alternatively, if the third virtual character is automatically eliminated for another external reason, the terminal device/server may automatically obtain an elimination picture from the perspective of the third virtual character, and display the elimination picture in the picture editing area of the check-in editing interface.

For example, the user may delete a picture displayed by default in the picture editing area. The user may also upload a picture selected by the user in the picture editing area.

Operation 225: Receive an editing operation on the first social information on the check-in editing interface, the first social information including at least one of a text, a picture, a video, a check-in marker style, or the first event.

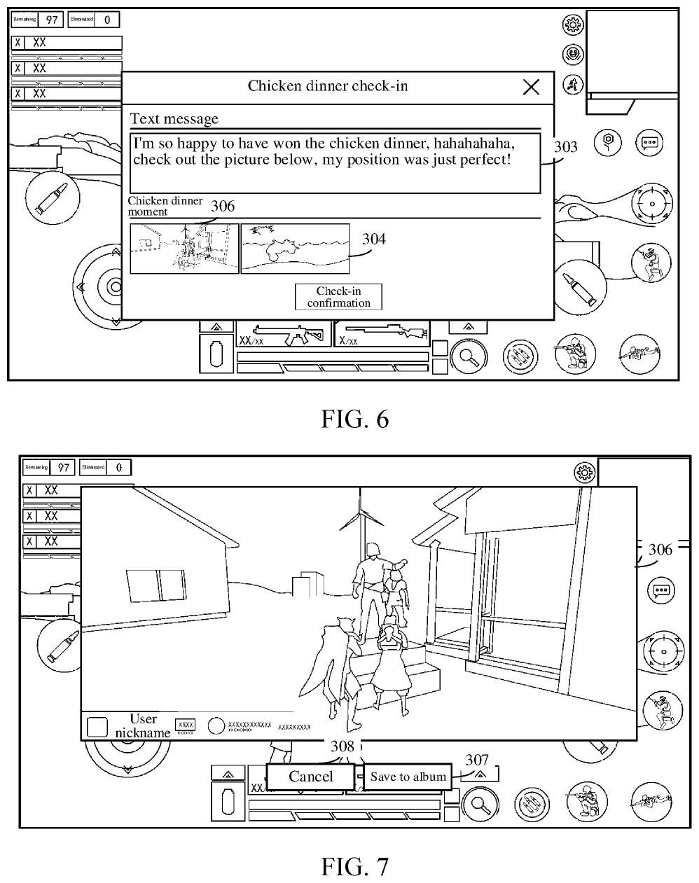

For example, as shown in FIG. 6, an operation of editing a text “I'm so happy to have won the chicken dinner, hahahahaha, check out the picture below, my position was just perfect” in the text editing area 303 of the check-in editing interface may be received. Two defeat pictures automatically obtained by a system may be further displayed in the picture editing area 304 of the check-in editing interface. In response to tapping/clicking a first defeat picture 306, an interface shown in FIG. 7 may be displayed. The first defeat picture 306 may be enlarged and displayed, and a save-to-album control 307 and a cancel control 308 may be displayed. In response to triggering the save-to-album control 307, the terminal may save the first defeat picture 306 to a local album of the terminal device. In response to triggering the cancel control 308, the terminal may cancel enlarging and displaying of the first defeat picture 306, and return to display the check-in editing interface shown in FIG. 6.

A check-in operation may include an operation of editing the first social information received on the check-in editing interface, and a check-in confirmation operation. After editing social information, the user may perform the check-in confirmation operation, so that the social information may be posted and a check-in marker may be placed.

For example, a text editing operation triggered in the text editing area of the check-in editing interface may be received; picture selection, editing, and deletion operations triggered in the picture editing area are received; video selection, editing, and deletion operations triggered in the video editing area are received; audio recording, editing, deletion, and selection operations triggered in the audio editing area are received; an operation of selecting the check-in marker style triggered in the check-in marker style selection area may be received; and an event selection operation triggered in the event selection area may be received.

When the first event is that the first virtual character wins the battle, at least one of a text editing operation, a picture editing operation, a video editing operation, or an audio editing operation on the check-in editing interface may be received, and the first social information may be generated based on the foregoing operations.

When the first event is a prize quiz, an operation of inputting a first question in the question editing area, an operation of inputting a first answer in the answer editing area, and an operation of selecting a reward in the reward selection area are received. The first social information includes the first question, the first answer, and the reward.

When the first event is sending a red packet, an operation of editing a quantity of red packets in the red packet quantity editing area, an operation of editing a red packet amount in the red packet amount editing area, an operation of selecting a red packet sending rule in the red packet sending rule selection area, an operation of editing a red packet collector limit condition in the red packet collector limit condition editing area, and the like are received. The first social information may include at least one piece of information of the quantity of red packets, the red packet amount, the red packet sending rule, or the red packet collector limit condition.

When the first event is selling a virtual item, an operation of selecting a first virtual item in the virtual item selection area and an operation of editing a first selling amount in the selling amount editing area are received. The first social information may include at least one of the first virtual item or the first selling amount.

When the first event is exchanging virtual items, an operation of selecting a first virtual item as a virtual item for exchange and an operation of selecting a second virtual item as a desired virtual item are received. The first social information may include item information of the first virtual item and the second virtual item.

When the first event is summoning the first virtual character, an operation of selecting a summon condition and an operation of editing a first virtual character introduction are received. The first social information may include the summon condition and the first virtual character introduction.

For example, the check-in editing interface may include a check-in confirmation control. In response to triggering the check-in confirmation control, the check-in editing interface may be exited, and operation 230 may be performed to create the first check-in marker in the three-dimensional virtual environment.

In some aspects, in response to triggering the check-in confirmation control, the terminal device may send the first social information to the server. The server associatively may store the first social information, the second position, the first check-in marker, and the three-dimensional virtual environment (or a first map/map label corresponding to the three-dimensional virtual environment). In some aspects, the server may permanently store the foregoing information. In response to receiving a check-in success message sent by the server, the terminal may perform operation 230 of displaying the first check-in marker at the second position in the three-dimensional virtual environment.

Operation 230: Display the first check-in marker created by the first virtual character at the second position in the three-dimensional virtual environment, the first check-in marker being configured for displaying, to a virtual character arriving at the second position, the first social information edited by the first virtual character for the first event.

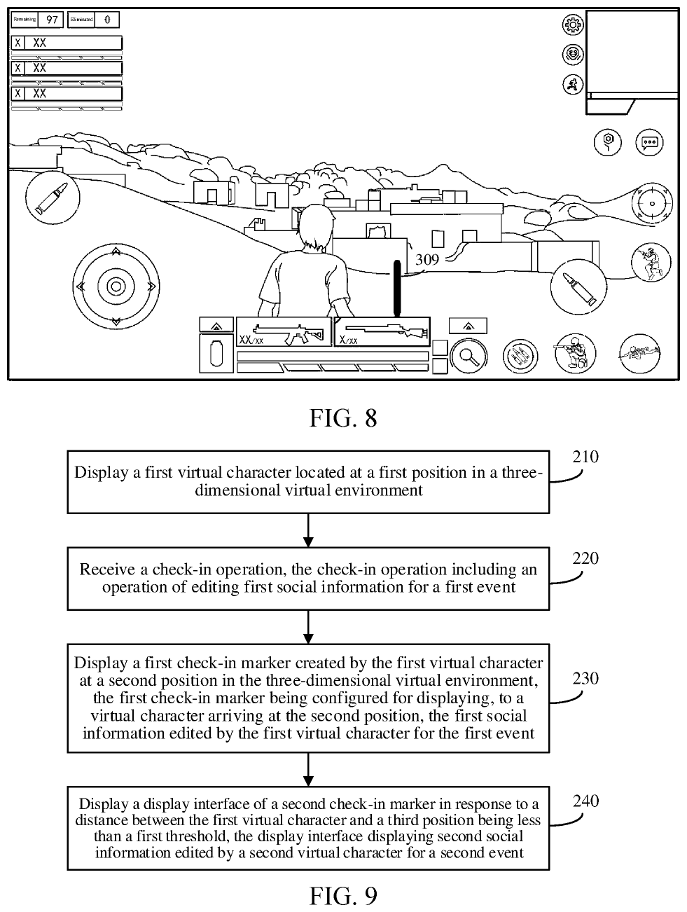

For example, as shown in FIG. 8, after the check-in operation is completed, the terminal may display a first check-in marker 309 at the second position in the three-dimensional virtual environment.

For example, in the three-dimensional virtual environment, there may be not only a check-in marker created by the first virtual character, but also a check-in marker created by another virtual character. In some aspects, a display style of the check-in marker created by the another virtual character may be different from a display style of the check-in marker created by the first virtual character. For example, the check-in marker created by the another virtual character may be displayed as a cyan light beam, and the check-in marker created by the first virtual character may be displayed as a red light beam.

Based on the above, according to the method provided in this disclosure, the check-in editing interface may be displayed, so that the user can edit and post at least one type of social information of a text, a picture, a video, audio, or an event. The user may create a check-in marker in the three-dimensional virtual environment after completing checking in and posting the social information, so that another virtual character approaching the check-in marker can see the social information posted by the first virtual character.

According to the method provided in this disclosure, a picture that may be automatically obtained by the system and that may be related to the first event may be displayed in the picture editing area of the check-in editing interface. This simplifies a user operation, and the user can quickly edit the social information for the first event, to improve human-computer interaction efficiency.

According to the method provided herein, when the first virtual character wins the first battle, defeat pictures from perspectives of both sides in a final defeat are automatically obtained, and the defeat pictures are displayed in the picture editing area, so that a highlight moment when the first virtual character wins the battle may be presented in a plurality of perspectives. This may be convenient for the user to edit the social information to share a win, and improves the human-computer interaction efficiency.

FIG. 9 is a flowchart of a social method based on a three-dimensional virtual environment. Based on the illustrative aspect shown in FIG. 2, operation 240 may be further included after operation 230.

Operation 240: Display a display interface of a second check-in marker in response to a distance between the first virtual character and a third position being less than a first threshold, the display interface displaying second social information edited by a second virtual character for a second event.

In some aspects, the three-dimensional virtual environment may further include a check-in marker created by another virtual character, for example, the second check-in marker created by the second virtual character and located at the third position.

A method in which a virtual character approaches and interacts with a check-in marker is described below by using the second check-in marker as an example.

The second check-in marker created by the second virtual character may be displayed at the third position in the three-dimensional virtual environment.

The second virtual character and the first virtual character may be virtual characters controlled by different user accounts. In other words, the virtual character may be not allowed to view a check-in marker created by the virtual character. Alternatively, the second virtual character and the first virtual character may be a same virtual character. In other words, the virtual character can approach and view a check-in marker created by the virtual character.

The second virtual character and the first virtual character may be virtual characters that jointly participate in a current battle (the first battle), that is, both the first check-in marker and the second check-in marker may be created in the first battle.

Alternatively, the second virtual character and the first virtual character may be virtual characters respectively participating in different battles. For example, the first virtual character may create the first check-in marker in the first battle, and the second virtual character may create the second check-in marker in a second battle. Battle start time of the second battle may be later than creation time of the first check-in marker. The first battle and the second battle may be two battles performed in the same three-dimensional virtual environment. For example, the first battle and the second battle may be both game battles performed in a three-dimensional virtual environment of the first map.

When the first virtual character approaches the second check-in marker, a reply control may be displayed on a battle interface. In response to receiving a triggering operation on the reply control, the terminal displays the display interface corresponding to the second check-in marker.

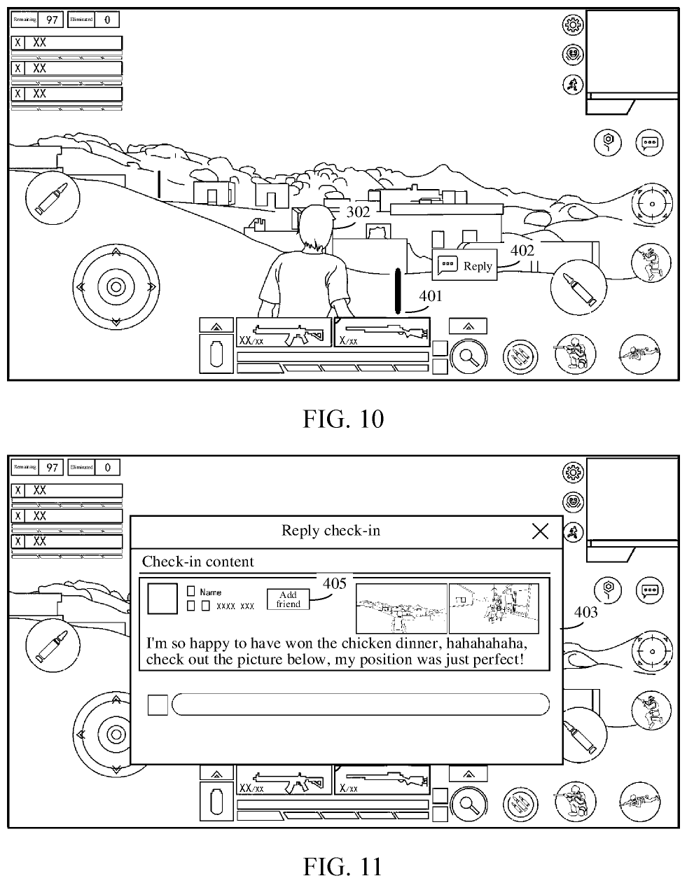

For example, as shown in FIG. 10, a second check-in marker 401 created by the second virtual character may be displayed at the third position in the three-dimensional virtual environment. When the first virtual character 302 approaches the second check-in marker 401, the terminal may display a reply control 402. In response to triggering the reply control 402, a display interface 403 of the second check-in marker shown in FIG. 11 may be displayed.

The display interface may include the second social information posted by the second virtual character for the second event. In some aspects, the display interface may further include character information of the second virtual character. For example, the character information includes at least one of an avatar, a nickname, an organization to which the character belongs, a rank name, a rank icon, a personal signature, or last online time. In some aspects, the display interface may further include at least one piece of information of a second event name, second event occurrence time, second social information posting time, at least one piece of reply information, or character information of a replier.

In addition to displaying the second social information, the display interface may be further configured for interacting with a virtual character viewing the second social information. For example, the virtual character viewing the second social information may reply to the second social information, add the second virtual character as a friend, save a picture/a video/audio in the second social information, collect a reward in the second social information, obtain a virtual item in the second social information, and the like.

In some aspects, the display interface may further include at least one interaction control. For example, the display interface includes a reply editing control. The reply editing control may be configured for editing reply information and posting the reply information. For another example, the display interface includes a social relationship establishment control. The social relationship establishment control may be configured for triggering establishment of a social relationship (for example, establishment of a friend relationship) with the second virtual character. For another example, the display interface may include a three-dimensional model display entrance. The three-dimensional model display entrance may be configured for opening a three-dimensional model display interface to display a related picture of a three-dimensional model display in the second social information.

Several interaction manners are described below.

### 1. Reply.

The display interface further includes the reply editing control. The terminal device receives a reply operation on the reply editing control, the reply operation including an operation of editing the reply information; and the terminal device replies to the second social information based on the reply information.

The reply information includes at least one piece of information of a text, a picture, and an emote.

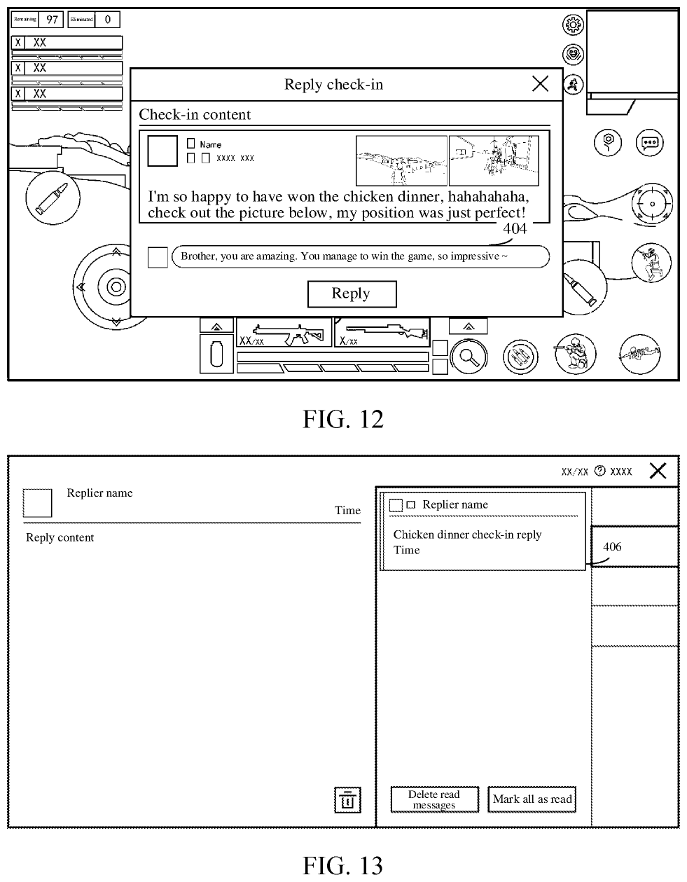

For example, as shown in FIG. 12, in a text editing area 404 on the display interface, reply information “Brother, you are amazing. You manage to win the game, so impressive” may be edited and replied.

In some aspects, a manner of replying to the second social information may be sending a reply mail to the second virtual character. For example, the reply mail for the second social information may be transmitted to a second user account corresponding to the second virtual character. The reply mail includes the reply information. The second virtual character may view the reply information by viewing the reply mail.

For example, as shown in FIG. 13, a reply mail 406 for a current reply may be received in a mailbox of the second virtual character, and the second virtual character may also reply to the reply mail of the first virtual character.

The manner of replying to the second social information may alternatively be displaying the reply information on the display interface. The reply information of the first virtual character replying to the second social information may be displayed on the display interface. The second virtual character may view the reply information on the display interface, and another virtual character may also view the reply information on the display interface.

In some aspects, when the first virtual character replies to the second social information in the three-dimensional virtual environment, and the second virtual character is located in the three-dimensional virtual environment, the second social information may be directly displayed on the display interface. When the second virtual character has exited the three-dimensional virtual environment, in addition to being displayed on the display interface, the second social information may be also sent to a second user account in a form of an e-mail.

### 2. Establish a Social Relationship.

The display interface may further include the character information of the second virtual character and the social relationship establishment control. An application for establishing a social relationship with the second virtual character may be transmitted in response to receiving a triggering operation on the social relationship establishment control. The social relationship may include but is not limited to a friend relationship, a single-directional follow relationship, and a bidirectional follow relationship.

For example, as shown in FIG. 11, a friend adding control 405 may be displayed on the display interface. In response to receiving a triggering operation on the friend adding control, a friend adding request may be sent to the second user account corresponding to the second virtual character.

In response to receiving the triggering operation on the friend adding control, the terminal device may send a friend adding request to the server, the friend adding request including the second user account of the second virtual character. The server may send the friend adding request to a second client where the second user account may be located. The second client may display the friend adding request from the first virtual character. A friend consent message may be sent to the server in response to receiving a consent operation. The server may receive the friend consent message sent by the second client, establish a friend relationship between a first user account of the first virtual character and the second user account, and send a friend adding success message to the terminal device. The terminal device may receive the friend adding success message, and display establishment of the friend relationship with the second user account.

### 3. Special Interaction.

The display interface may further include a completion condition and a completion reward corresponding to the second event. In response to the first virtual character meeting the completion condition, the display interface may display that the first virtual character has obtained the completion reward. For example, the second event may be: at least one of a prize quiz, snatching a red packet, selling a virtual item, exchanging virtual items, or summoning the second virtual character.

### (1) Prize Quiz

In some aspects, the completion condition may include answering a question correctly, and the completion reward may include a reward provided in the second social information. The second social information on the display interface may include a question and a reply editing control. The reply information may be sent in response to receiving an editing operation on the reply information triggered through the reply editing control. When the reply information is a correct answer to the question, the display interface may display that the first virtual character obtains the reward in the second social information.

### (2) Snatching the Red Packet

In some aspects, the completion condition may include snatching the red packet, and the completion reward may include the red packet provided in the second social information. The display interface may include a red packet snatching control. In response to receiving a triggering operation on the red packet snatching control, the display interface may display that the first virtual character has obtained the red packet in the second social information.

### (3) Selling the Virtual Item

In some aspects, the completion condition may include paying a virtual resource, and the completion reward may include the second virtual item of the second virtual character. The second virtual item sold by the second virtual character in the second social information and a selling amount of the second virtual item may be displayed on the display interface, and the display interface further includes a purchase control. In response to receiving a triggering operation on the purchase control, the display interface displays that the first virtual character obtains the second virtual item. A virtual resource of the first virtual character may be reduced based on the selling amount, and a virtual resource of the second virtual character may be increased based on the selling amount.

### (4) Exchanging the Virtual Items

In some aspects, the completion condition may include exchanging the first virtual item, and the completion reward may include the second virtual item of the second virtual character. In response to an operation of exchanging the first virtual item by the first virtual character, the display interface may display that the first virtual character has lost the first virtual item and obtained the second virtual item. An owner of the first virtual item may be changed from the first virtual character to the second virtual character, and an owner of the second virtual item may be changed from the second virtual character to the first virtual character.

### (5) Summoning the Second Virtual Character

In some aspects, the completion condition may include paying a virtual resource, and the completion reward may include summoning the second virtual character to the third position. An amount required for summoning and a summon control may be displayed on the display interface. The second virtual character may be displayed at the third position in the three-dimensional virtual environment in response to receiving a triggering operation on the summon control. A virtual resource of the first virtual character may be reduced based on the amount required for summoning, and a virtual resource of the second virtual character may be increased based on the amount required for summoning. In this way, the first virtual character may temporarily summon the second virtual character to participate in a game battle as a teammate. In an optional aspect, when a duration for which the second virtual character exists reaches a threshold, the second virtual character may be controlled to exit the second battle.

According to the method provided in this disclosure, the another virtual character may further reply to the social information on the check-in marker, and then communicate with the virtual character that posts the social information, to implement game insight sharing in the game battle, and promote communication between stranger players.

According to the method provided in this disclosure, the reply to the social information may be sent to the publisher by e-mailing, or may be displayed on the display interface of the social information, to facilitate communication between the replier and the publisher.

According to the method provided in this disclosure, the another virtual character viewing the social information may also add the publisher as a friend. This expands a way for the user to add a friend.

According to the method provided in this disclosure, the virtual character may also use a check-in marker to exchange the virtual items with another virtual character in the three-dimensional virtual environment. The virtual character creates the check-in marker and releases an intention to exchange on the check-in marker. When the another virtual character views the check-in marker and agrees to exchange, the two virtual characters may complete the exchange of the virtual item. In this way, the two virtual characters can asynchronously complete the exchange of the virtual items. This does not require that the two virtual characters need to arrive at the same position at the same time, and simplifies a virtual item exchange procedure.

An illustrative aspect may be provided in which after a win may be obtained, the win may be shared with the another virtual character by creating the check-in marker.

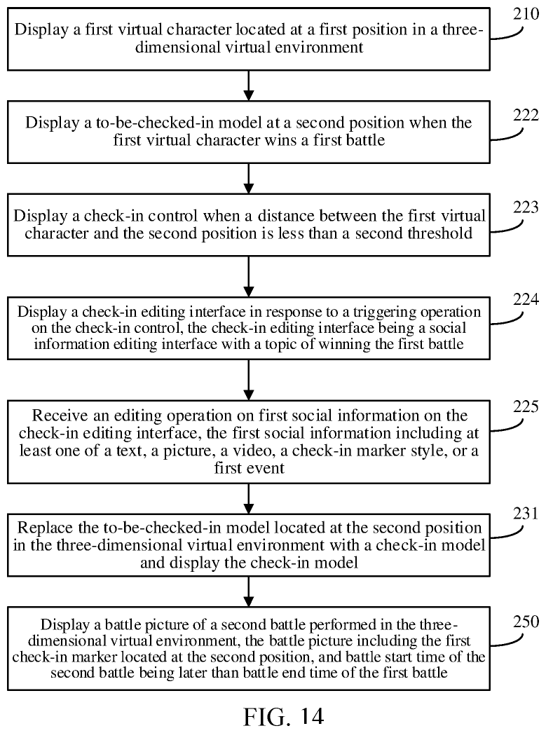

FIG. 14 is a flowchart of a social method based on a three-dimensional virtual environment. Based on the aspect shown in FIG. 2, operation 220 may be replaced with operation 222, operation 223, operation 224, and operation 225, operation 230 may be replaced with operation 231, and operation 250 may be further included after operation 230.

Operation 210: Display a first virtual character located at a first position in a three-dimensional virtual environment.

For example, the first virtual character may perform a first battle in a first map. The first position may be a position at which the first virtual character wins the first battle. A first event may include that the first virtual character won the first battle, and the first battle may be a game battle performed in the three-dimensional virtual environment.

Operation 222: Display a to-be-checked-in model at a second position when the first virtual character wins the first battle.

For example, the second position may be a position directly in front of the first virtual character by a fixed distance when the first virtual character may be located at the first position.

The to-be-checked-in model may be displayed as a dim gray light beam.

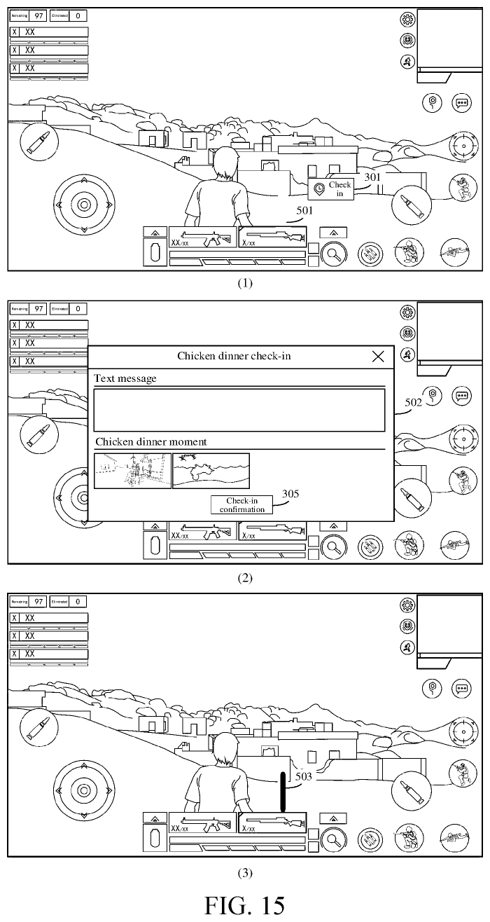

For example, as shown in (1) in FIG. 15, after the first virtual character has a chicken dinner, a to-be-check-in model 501 may be displayed on a ground in front of the first virtual character.

Operation 223: Display a check-in control when a distance between the first virtual character and the second position is less than a second threshold.

When the first virtual character approaches the to-be-checked-in model, the check-in control may be displayed on a battle interface, and the check-in control may be configured for opening a check-in editing interface.

For example, as shown in (1) in FIG. 15, when the first virtual character approaches a to-be-checked-in model 501, a check-in control 301 may be displayed on the battle interface.

Operation 224: Display the check-in editing interface in response to a triggering operation on the check-in control, the check-in editing interface being a social information editing interface with a topic of winning the first battle.

The social information editing interface with the topic of winning the first battle may be an interface on which a text prompt for winning the first battle may be displayed, an icon for winning may be displayed, or the like.

For example, as shown in (2) in FIG. 15, when a user triggers the check-in control, a terminal may display a check-in pop-up window (check-in editing interface) 502 on the battle interface. The check-in editing interface displays a topic “chicken dinner check-in” of current checking in.

Operation 225: Receive an editing operation on first social information on the check-in editing interface, the first social information including at least one of a text, a picture, a video, a check-in marker style, or a first event.

For example, as shown in (2) in FIG. 15, the user may edit the first social information on the check-in editing interface, and after completing editing, the user taps/clicks a check-in confirmation control 305 to complete current checking in.

Operation 231: Replace the to-be-checked-in model located at the second position in the three-dimensional virtual environment with a check-in model and display the check-in model.

In some aspects, when the to-be-checked-in model may be replaced with the check-in model, only a display state of the to-be-checked-in model may be updated. For example, a color of the to-be-checked-in model may be updated. Alternatively, the entire model may be replaced. For example, a to-be-checked-in model in a light beam form may be replaced with a check-in model in a chess piece form.

After the checking in is completed, the check-in editing interface may be turned off, and a battle picture may be re-displayed. The to-be-checked-in model in the battle picture may be replaced with the check-in model. The check-in model may be a first check-in marker, and the check-in model may be displayed as a red light beam. For example, as shown in (3) in FIG. 15, a check-in model 503 may be displayed at the second position in the three-dimensional virtual environment.

Another virtual character approaches the check-in model to view the first social information posted by the first virtual character.

For example, the check-in model, the second position, and the first social information may be associatively stored in a server. The server may permanently store the foregoing information, and read, after a win is obtained in each game battle performed in the first map, data related to all check-in models in the first map, and displays the check-in models in the three-dimensional virtual environment of the first map.

For example, the check-in marker (check-in model) may be displayed in the three-dimensional virtual environment of the game battle only within a period of time when the virtual character exits the game battle after a win may be obtained in the game battle. The virtual character can create the check-in marker, view the check-in marker, and reply to the check-in marker only within the period of time.

Operation 250: Display a battle picture of a second battle performed in the three-dimensional virtual environment, the battle picture including the first check-in marker located at the second position, and battle start time of the second battle being later than battle end time of the first battle.

The first check-in marker (check-in model) may be created by the first virtual character in the first battle, and the first battle may be a game battle performed in the three-dimensional virtual environment.

The second battle may be a battle spectated by a first user account corresponding to the first virtual character. The second battle may alternatively be a battle in which the first user account participates. The second battle may alternatively be a battle in which another user account may be used for participating after the another user account is logged in on a terminal device.

The first battle and the second battle are two battles performed in the same three-dimensional virtual environment. In some aspects, both the first battle and the second battle may be battles performed in the three-dimensional virtual environment of the first map.

In some aspects, a check-in marker created by another virtual character may be displayed in the three-dimensional virtual environment only after a win is obtained in the second battle. When a fifth virtual character wins the second battle, a terminal may obtain a check-in marker dataset stored in association with the three-dimensional virtual environment, the check-in marker dataset including check-in marker data of at least one check-in marker, and the check-in marker being created by at least one virtual character that wins a battle and checks in in the three-dimensional virtual environment. The terminal may render and display, based on check-in marker data of the first check-in marker in the check-in marker dataset, the first check-in marker at the second position in the three-dimensional virtual environment, to obtain the battle picture of the second battle.

The first virtual character and the fifth virtual character are virtual characters controlled by the same user account, or the first virtual character and the fifth virtual character are virtual characters controlled by different user accounts.

Based on the above, according to the method provided in this disclosure, when the virtual character wins the battle, a dim gray light beam may be displayed in the virtual environment, and when the virtual character approaches the dim gray light beam, the check-in control may be displayed. The user may trigger the check-in control to open the check-in editing interface, to edit and post winning presentation. In this way, one piece of winning social information may be left in the three-dimensional virtual environment, and another virtual character can approach the light beam and view the winning social information, to achieve a purpose of sharing a win to the another virtual character. In addition, the virtual character may edit a text related to a winning method, to teach in the field a trick to win near a position point. This facilitates communication between users.

According to the method provided in this disclosure, the check-in model created by the virtual character in the three-dimensional virtual environment may be permanently stored in the three-dimensional virtual environment, and displayed to a virtual character participating in a subsequent battle in the three-dimensional virtual environment, so that the virtual character can communicate with respect to a position in the three-dimensional virtual environment, or communicate with respect to an event occurring at a position in the three-dimensional virtual environment. In this way, a new communication manner may be provided, so that the virtual character can sense the environment in which the event occurs during communication.

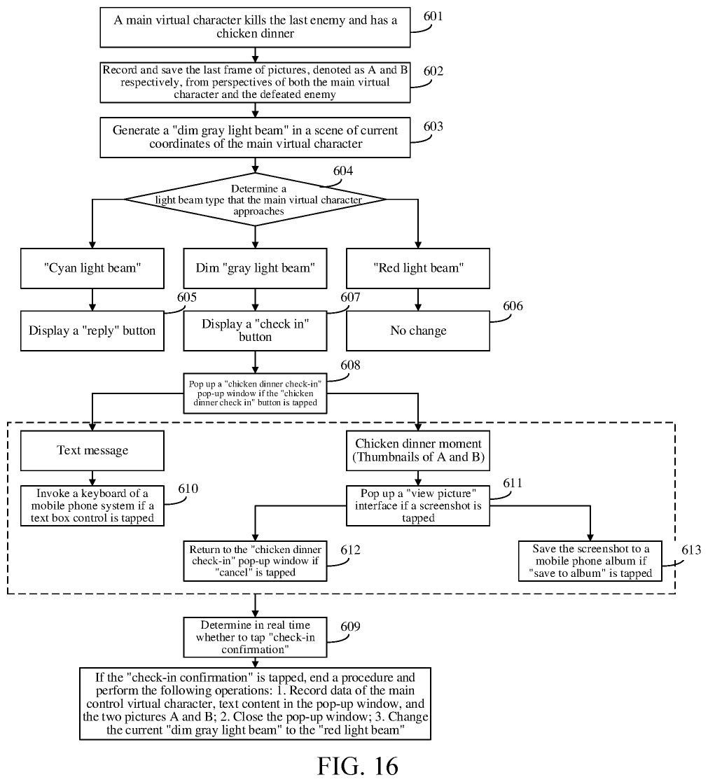

FIG. 16 may be a flowchart of a social method based on a three-dimensional virtual environment according to an illustrative aspect. The method includes the following operations.

Operation 601: A main virtual character may defeat the last enemy to finally win a chicken dinner or have a chicken dinner.

Operation 602: A system may need to record and save the last frame of pictures, denoted as A and B, from perspectives of both the main virtual character and a killed person. A and B may be two defeat pictures.

Operation 603: Generate a “dim gray light beam” in a scene of current coordinates of the main virtual character.

For example, check-in markers of three types may be displayed in the three-dimensional virtual environment. One type is: a check-in marker to be checked in; one type is: a check-in marker for a current virtual character/current user account to check in; and one type is: a check-in marker for another virtual character/another user account to check in.

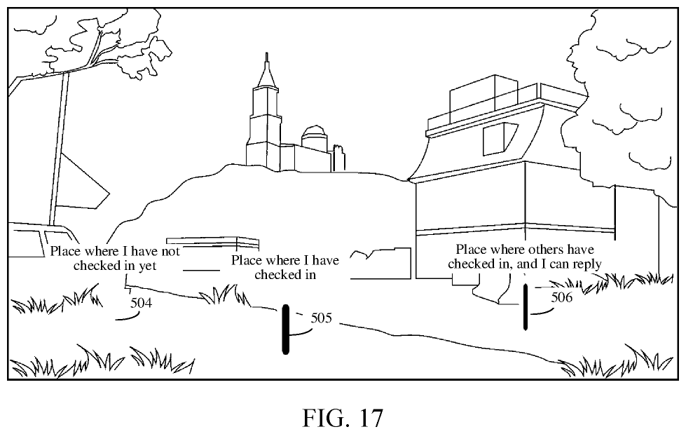

As shown in FIG. 17, the check-in marker to be checked in may be displayed as a dim gray light beam 504; the check-in marker for the current virtual character/current user account to check in may be displayed as a red light beam 505; and the check-in marker for the another virtual character/another user account to check in may be displayed as a cyan light beam 506.

Operation 604: Determine a light beam model that the main virtual character approaches.

Operation 605: Display a “reply” button on a screen if there is the “cyan light beam”.

Operation 606: There may be no change if there is the “red light beam”. The main virtual character cannot view social information posted by the main virtual character.

Operation 607: Display a “check in” button if there is the “dim gray light beam”.

Operation 608: Determine whether the “check in” button is tapped; and Pop up a “chicken dinner check-in” pop-up window if a tap behavior is performed.

Operation 609: From this moment until the main control virtual character closes the “chicken dinner check-in” pop-up window, it needs to be determined in real time whether to tap “check-in confirmation”. If the check-in confirmation is tapped, a check-in procedure ends, and data of social information in the check-in pop-up window, text content in the pop-up window, and the two pictures A and B are recorded. The pop-up window may be closed, and the current “dim gray light beam” may be changed to the “red light beam”.

Operation 610: As shown in (2) in FIG. 15, there may be a universal text box control above the “chicken dinner check-in” pop-up window. It may be determined whether the text box control may be tapped. If the text box control may be tapped, a universal keyboard of a terminal device system may be invoked.

Operation 611: As shown in (2) in FIG. 15, below the “chicken dinner check-in” pop-up window are thumbnails of two screenshots A and B, and it may be determined whether to tap the screenshot. If A/B may be tapped, a “view picture” interface may be opened. The “view picture” interface displays an enlarged A/B, a “cancel” button, and a “save to album” button.

Operation 612: Determine whether to tap the “cancel” button, and if the button is tapped, return to the “chicken dinner check-in” pop-up window.

Operation 613: Determine whether to tap the “save to album” button, and if the button is tapped, save the screenshot to the system album of the terminal device.

Based on the above, according to the method provided above, by checking in in the three-dimensional virtual environment, a player satisfies desire to brag after having a chicken dinner. This enhances a sense of glory of the player when the player has a chicken dinner. In addition, a user-friendly social behavior may be promoted in an asynchronous social manner, and communication between players may be improved. This serves as an icebreaker for a series of subsequent social features. In addition, the entire system supports two manners: manual input of a text and automatic screenshot of the system, and a full function and a convenient and quick interaction manner can well improve experience of the user when the user plays a game.

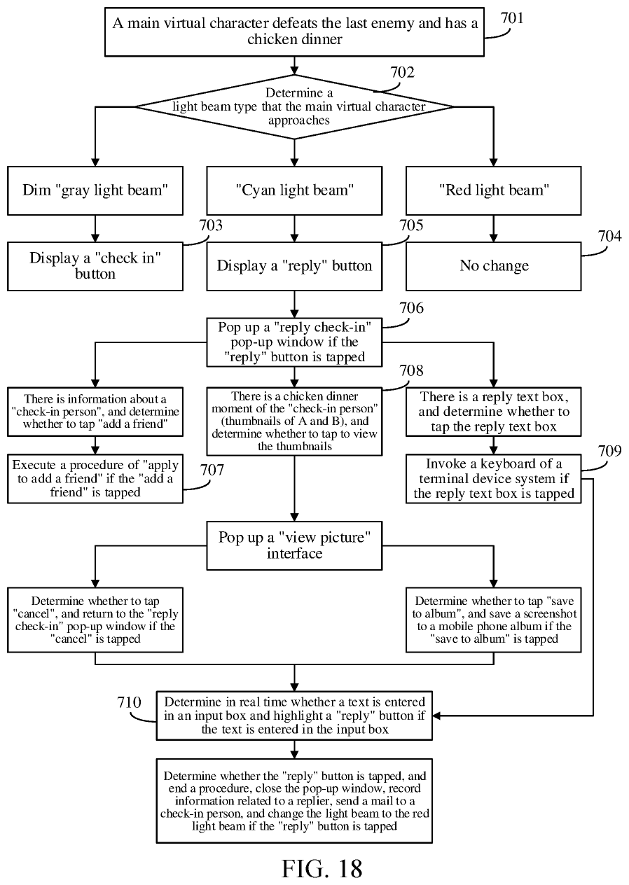

FIG. 18 is a flowchart of a social method based on a three-dimensional virtual environment according to an illustrative aspect. The method includes the following operations.

Operation 701: The last enemy may be defeated, and a main virtual character may win or have a chicken dinner.

Operation 702: Display all light beams (check-in markers) in a scene (in the three-dimensional virtual environment), and determine a light beam type that the main virtual character approaches.

Operation 703: Perform the method procedure shown in FIG. 16 if the main virtual character approaches a dim “gray light beam”.

Operation 704: If the main virtual character approaches a “red light beam”, there is no change.

Operation 705: Display a “reply” button on a screen if the main control virtual character approaches a “cyan light beam”.

Operation 706: Determine whether the “reply” button is tapped, and pop up a “reply check-in” pop-up window if the “reply” button is tapped.

Operation 707: As shown in FIG. 11, an upper left part of the “reply check-in” pop-up window (display interface 403) may be information about a “check-in person”, and data stored when the check-in person checks in may be read, which are an avatar, a name, an organization to which the check-in person belongs, a rank badge, and a rank name respectively. There may be a “add a friend” button to the right of the “reply check-in” pop-up window. It may be determined whether the “add a friend” button is tapped. If the button is tapped, a procedure of “applying to add a friend” may be entered, and the button may be hidden.

Operation 708: As shown in FIG. 11, an upper right side of the “reply check-in” pop-up window (display interface 403) may be a chicken dinner moment of the “check-in person”, and social information edited by the check-in person may be displayed: a text, a picture A, and a picture B. It may be determined whether to tap to view the picture A/picture B. If tapping is performed, a “view picture” interface may be displayed. It may be determined whether a “cancel” button is tapped. If the button is tapped, it may return to the “reply check-in” pop-up window. It may be determined whether a “save to album” button is tapped. If the button is tapped, the picture A/picture B may be saved to the mobile phone album.

Operation 709: As shown in FIG. 11, below the “reply check-in” pop-up window (display interface 403) may be a reply text box. It may be determined whether the reply text box is tapped. If the reply text box is tapped, a mobile phone system keyboard may be invoked.

Operation 710: As shown in FIG. 11, a lowermost part of the “reply check-in” pop-up window (display interface 403) may be a “reply” button. A terminal device determines in real time whether a text may be entered in the text box. If there is no text entered in the text box, the button may be grayed out and cannot be tapped. If there is a text entered in the text box, the button may be highlighted and a procedure may end after the button is tapped, the “reply check-in” pop-up window is closed, the information related to the “check-in person” is recorded, and a mail is sent to the “check-in person”. In addition, the cyan light beam may be changed to the red light beam, and when a replier subsequently approaches the light beam, there may be no longer any interaction function.

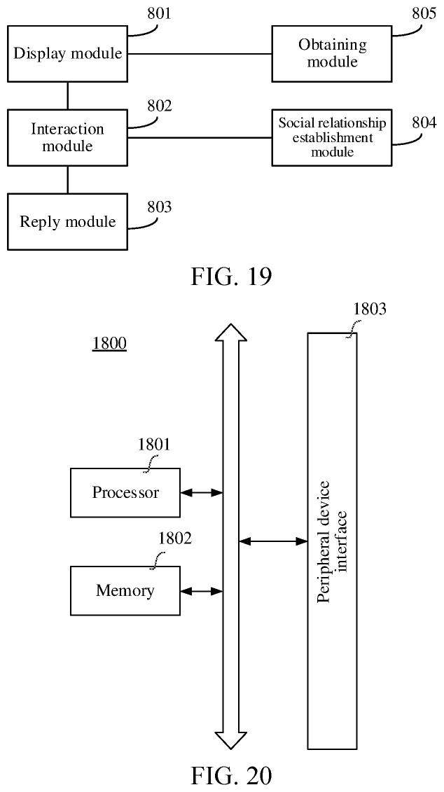

FIG. 19 is a block diagram of a structure of a social apparatus based on a three-dimensional virtual environment according to an illustrative aspect. The apparatus includes:

a display module 801, configured to display a first virtual character located at a first position in a three-dimensional virtual environment; and

an interaction module 802, configured to receive a check-in operation, the check-in operation including an operation of editing first social information for a first event; and

the display module 801 being configured to display a first check-in marker created by the first virtual character at a second position in the three-dimensional virtual environment, and the first check-in marker being configured for displaying, to a virtual character arriving at the second position, the first social information edited by the first virtual character for the first event.

In an optional aspect, a second check-in marker created by a second virtual character may be displayed at a third position in the three-dimensional virtual environment; and

the display module 801 may be configured to display a display interface of the second check-in marker when a distance between the first virtual character and the third position may be less than a first threshold, the display interface displaying second social information edited by the second virtual character for a second event.

In an optional aspect, the display interface further includes a reply editing control, and the apparatus further includes:
the interaction module 802, configured to receive a reply operation on the reply editing control, the reply operation including an operation of editing reply information; and
a reply module 803, configured to reply to the second social information based on the reply information.

In an optional aspect, the reply module 803 may be configured to transmit, to a second user account corresponding to the second virtual character, a reply mail for the second social information, the reply mail including the reply information;
or
display the reply information of the first virtual character replying to the second social information on the display interface.

In an optional aspect, the display interface further includes character information of the second virtual character and a social relationship establishment control, and the apparatus further includes:
a social relationship establishment module 804, configured to transmit an application for establishing a social relationship with the second virtual character in response to receiving a triggering operation on the social relationship establishment control.

In an optional aspect, the display module 801 may be configured to display a check-in editing interface, the check-in editing interface including at least one of a text editing area, a picture editing area, a video editing area, a check-in marker style selection area, or an event selection area; and
the interaction module 802 may be configured to receive an operation on the first social information on the check-in editing interface, the first social information including at least one of a text, a picture, a video, a check-in marker style, or the first event.

In an optional aspect, the check-in editing interface includes the picture editing area, and the picture editing area displays, by default, at least one picture automatically obtained for the first event.

In an optional aspect, the first event includes that the first virtual character wins a first battle;
when a third virtual character may be defeated causing the first virtual character to win the first battle, the at least one picture includes a picture, obtained from a perspective of the third virtual character, that the third virtual character may be defeated; and
when a fourth virtual character defeats the third virtual character causing the first virtual character to win the first battle, the at least one picture includes a picture, obtained from the perspective of the third virtual character, that the third virtual character may be defeated, and a picture, obtained from a perspective of the fourth virtual character, that the fourth virtual character defeats the third virtual character.

The first virtual character and the fourth virtual character are a same virtual character, or the first virtual character and the fourth virtual character are virtual characters of a same camp.

In an optional aspect, the first event includes that the first virtual character wins the first battle.

The display module 801 may be configured to display a to-be-checked-in model at the second position when the first virtual character wins the first battle.

The display module 801 may be configured to display a check-in control when a distance between the first virtual character and the second position may be less than a second threshold.

The display module 801 may be configured to display the check-in editing interface in response to a triggering operation on the check-in control, the check-in editing interface being a social information editing interface with a topic of winning the first battle.

In an optional aspect, the first check-in marker may be displayed as a check-in model.

The display module 801 may be configured to replace the to-be-checked-in model located at the second position in the three-dimensional virtual environment with the check-in model and display the check-in model.

In an optional aspect, the first check-in marker may be created by the first virtual character in the first battle, the first battle being a game battle performed in the three-dimensional virtual environment.

The display module 801 may be configured to display a battle picture of a second battle performed in the three-dimensional virtual environment, the battle picture including the first check-in marker located at the second position, and battle start time of the second battle being later than battle end time of the first battle.

In an optional aspect, the apparatus further includes:
an obtaining module 805, configured to: when a fifth virtual character wins the second battle, obtain a check-in marker dataset stored in association with the three-dimensional virtual environment, the check-in marker dataset including check-in marker data of at least one check-in marker, and the check-in marker being created by at least one virtual character that wins a battle and checks in in the three-dimensional virtual environment; and
the display module 801, configured to render and display the first check-in marker at the second position in the three-dimensional virtual environment based on check-in marker data of the first check-in marker in the check-in marker dataset, to obtain the battle picture of the second battle,
the first virtual character and the fifth virtual character being virtual characters controlled by a same user account, or the first virtual character and the fifth virtual character being virtual characters controlled by different user accounts.

In an optional aspect, the display interface further includes a completion condition and a completion reward corresponding to the second event, and
the display module 801 may be configured to display, when the first virtual character meets the completion condition, that the first virtual character obtains the completion reward.

In an optional aspect, the completion condition includes exchanging a first virtual item, and the completion reward includes a second virtual item of the second virtual character; and
the display module 801 may be configured to display, in response to an operation of exchanging the first virtual item by the first virtual character, that the first virtual character loses the first virtual item and obtain the second virtual item,
an owner of the first virtual item being changed from the first virtual character to the second virtual character, and an owner of the second virtual item being changed from the second virtual character to the first virtual character.

FIG. 20 is a block diagram of a structure of a computer device 1800 according to an illustrative aspect. The computer device 1800 may be a portable mobile terminal, for example, a smartphone, a tablet computer, a moving picture experts group audio layer III (MP3) player, a moving picture experts group audio layer IV (MP4) player, a notebook computer, or a desktop computer. The computer device 1800 may also be referred to as another name such as user equipment, a portable terminal, a laptop terminal, or a desktop terminal.

Usually, the computer device 1800 includes: a processor 1801 and a memory 1802.

The processor 1801 may include one or more processing cores, for example, a 4-core processor or an 8-core processor. The processor 1801 may be implemented in at least one hardware form of a digital signal processor (DSP), a field-programmable gate array (FPGA), and a programmable logic array (PLA). The processor 1801 may also include a main processor and a coprocessor. The main processor may be a processor configured for processing data in an awake state, and may be also referred to as a Central Processing Unit (CPU). The coprocessor may be a low power consumption processor configured for processing data in a standby state. In some aspects, the processor 1801 may be integrated with a graphics processing unit (GPU). The GPU may be configured for rendering and draw content that needs to be displayed on a display screen. In some aspects, the processor 1801 may further include an artificial intelligence (AI) processor. The AI processor may be configured to process computing operations related to machine learning.

The memory 1802 may include one or more computer-readable storage media. The computer-readable storage medium may be non-transient. The memory 1802 may further include a high-speed random access memory and a nonvolatile memory, for example, one or more disk storage devices or flash storage devices. In some aspects, the non-transient computer-readable storage medium in the memory 1802 may be configured for storing at least one instruction, the at least one instruction being configured for being executed by the processor 1801 to implement the social method based on the three-dimensional virtual environment provided in the method aspects.

In some aspects, the computer device 1800 further includes: a peripheral device interface 1803 and at least one peripheral device. The processor 1801, the memory 1802, and the peripheral device interface 1803 may be connected through a bus or a signal cable. Each peripheral device may be connected to the peripheral device interface 1803 through a bus, a signal cable, or a circuit board. For example, the peripheral device may include: at least one of a radio frequency circuit, a display screen, a camera assembly, an audio circuit, a sensor, or a power supply.

The peripheral device interface 1803 may be configured for connecting the at least one peripheral device related to input/output (I/O) to the processor 1801 and the memory 1802. In some aspects, the processor 1801, the memory 1802, and the peripheral device interface 1803 are integrated on the same chip or circuit board. In some other aspects, any one or two of the processor 1801, the memory 1802, and the peripheral device interface 1803 may be implemented on a single chip or circuit board. This is not limited in this aspect.

A person skilled in the art may understand that the structure shown in FIG. 20 constitutes no limitation on the computer device 1800, and the computer device 1800 may include more or fewer components than those shown in the figure, or some components may be combined, or a different component deployment may be used.

This disclosure further provides a computer-readable storage medium, the storage medium having at least one instruction, at least one program, a code set or an instruction set stored therein, and the at least one instruction, the at least one program, the code set or the instruction set being loaded and executed by a processor to implement the social method based on the three-dimensional virtual environment provided in the foregoing method aspects.

This disclosure provides a computer program product or a computer program, the computer program product or the computer program including computer instructions, and the computer instructions being stored in a computer-readable storage medium. A processor of a computer device reads the computer instructions from the computer-readable storage medium, and the processor executes the computer instructions, to enable the computer device to perform the social method based on the three-dimensional virtual environment provided in the foregoing method aspects.

The sequence numbers of the foregoing aspects are merely for description but do not imply the preference among the aspects.

A person of ordinary skill in the art may understand that all or some of the operations of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional, but are not intended to limit this disclosure. Any modification, equivalent replacement, or improvement made within the spirit and principle of this disclosure shall fall within the protection scope of this disclosure.

What is claimed is:

1. A method, comprising:
displaying, at a first position in a three-dimensional virtual environment, a first virtual character;
receiving a check-in operation, wherein the check-in operation comprises an operation of editing first social information for a first event in the three-dimensional virtual environment; and
generating, at a second position in the three-dimensional virtual environment, a first check-in marker indicating the first social information edited by the first virtual character for the first event.

2. The method of claim 1, further comprising:
displaying, at a third position in the three-dimensional virtual environment, a second check-in marker created by a second virtual character; and
displaying, based on a distance between the first virtual character and the third position being less than a threshold, a display interface of the second check-in marker, wherein the display interface indicates second social information edited by a second virtual character for a second event in the three-dimensional virtual environment.

3. The method of claim 2, wherein the display interface further indicates character information of the second virtual character and a social relationship establishment control, the method further comprising:
transmitting, based on receiving a triggering operation on the social relationship establishment control, an application for establishing a social relationship with the second virtual character.

4. The method of claim 2, wherein the display interface comprises a reply editing control, and the method further comprises:
receiving, via the reply editing control, reply information associated with the second social information; and
displaying the reply information.

5. The method of claim 4, further comprising
transmitting, to a second user account associated with the second virtual character, a reply mail for the second social information and comprising the reply information.

6. The method of claim 2, wherein the display interface further comprises a completion condition and a completion reward corresponding to the second event, the method further comprising:
displaying, when the first virtual character meets the completion condition, that the first virtual character has obtained the completion reward.

7. The method of claim 6, wherein the completion condition comprises exchanging a first virtual item, and the completion reward comprises a second virtual item of the second virtual character; and
wherein the displaying that the first virtual character has obtained the completion reward comprises:
in response to an exchange operation of exchanging the first virtual item by the first virtual character, displaying that the first virtual character is losing the first virtual item and obtaining the second virtual item,
displaying an owner of the first virtual item being changed from the first virtual character to the second virtual character; and
displaying an owner of the second virtual item being changed from the second virtual character to the first virtual character.

8. The method of claim 1, wherein the generating the check-in operation comprises:
displaying a check-in editing interface, wherein the check-in editing interface comprises at least one of a text editing area, a picture editing area, a video editing area, a check-in marker style selection area, or an event selection area; and
receiving, via the check-in editing interface, an editing operation on the first social information,
wherein the first social information comprises at least one of a text, a picture, a video, a check-in marker style, or data associated with the first event.

9. The method of claim 1, wherein the receiving a check-in operation comprises:
displaying a check-in editing interface, wherein the check-in editing interface comprises a picture editing area; and
displaying by default, via the picture editing area, at least one picture automatically obtained for the first event.

10. The method of claim 9, wherein the first event indicates that the first virtual character has won a first battle and a third virtual character is defeated; and
wherein the at least one picture comprises:
a first picture obtained from a perspective of the third virtual character and indicating that the third virtual character is defeated; and
a second picture obtained from a perspective of the first virtual character and indicating that the first virtual character defeated the third virtual character.

11. The method of claim 1, wherein the first event indicates that the first virtual character has won a first battle, the method further comprising:
displaying a to-be-checked-in model at the second position;
displaying, based on a distance between the first virtual character and the second position being less than a second threshold, a check-in control; and
displaying, based on receiving a triggering operation on the check-in control, a check-in editing interface indicating a topic of winning the first battle.

12. The method according to claim 11, wherein the first check-in marker is displayed as a check-in model; and
wherein the generating the first check-in marker comprises replacing the to-be-checked-in model located at the second position in the three-dimensional virtual environment with the check-in model.

13. The method of claim 1, wherein the first check-in marker is created by the first virtual character in a first battle, the method further comprising:
displaying, at the second position in the three-dimensional virtual environment, a battle picture of a second battle performed in the three-dimensional virtual environment, wherein the second battle happened after the first battle.

14. An apparatus, comprising:
one or more processors; and
memory storing instructions that, when executed by the one or more processors, cause the apparatus to:
display, at a first position in a three-dimensional virtual environment, a first virtual character;
receive a check-in operation, wherein the check-in operation comprises an operation of editing first social information for a first event in the three-dimensional virtual environment; and
generate, at a second position in the three-dimensional virtual environment, a first check-in marker indicating the first social information edited by the first virtual character for the first event.

15. The apparatus of claim 14, wherein the instructions, when executed by the one or more processors, further cause the apparatus to:
display, at a third position in the three-dimensional virtual environment, a second check-in marker created by a second virtual character; and
display, based on a distance between the first virtual character and the third position being less than a threshold, a display interface of the second check-in marker, wherein the display interface indicates second social information edited by a second virtual character for a second event in the three-dimensional virtual environment.

16. The apparatus of claim 14, wherein the instructions, when executed by the one or more processors, cause the apparatus to receive the check-in operation by:
displaying a check-in editing interface, wherein the check-in editing interface comprises at least one of a text editing area, a picture editing area, a video editing area, a check-in marker style selection area, or an event selection area; and
receiving, via the check-in editing interface, an editing operation on the first social information,
wherein the first social information comprises at least one of a text, a picture, a video, a check-in marker style, or data associated with the first event.

17. The apparatus of claim 14, wherein the instructions, when executed by the one or more processors, cause the apparatus to receive the check-in operation by:
displaying a check-in editing interface, wherein the check-in editing interface comprises a picture editing area; and
displaying by default, via the picture editing area, at least one picture automatically obtained for the first event.

18. A non-transitory computer-readable storage medium, storing computer readable instructions that, when executed by a processor, cause a data processing system to perform:
displaying, at a first position in a three-dimensional virtual environment, a first virtual character;
receiving a check-in operation, wherein the check-in operation comprises an operation of editing first social information for a first event in the three-dimensional virtual environment; and
generating, at a second position in the three-dimensional virtual environment, a first check-in marker indicating the first social information edited by the first virtual character for the first event.

19. The non-transitory computer-readable storage medium of claim 18, wherein the computer readable instructions that, when executed by the processor, further cause the data processing system to perform:
displaying, at a third position in the three-dimensional virtual environment, a second check-in marker created by a second virtual character; and
displaying, based on a distance between the first virtual character and the third position being less than a threshold, a display interface of the second check-in marker, wherein the display interface indicates second social information edited by a second virtual character for a second event in the three-dimensional virtual environment.

20. The non-transitory computer-readable storage medium of claim 18, wherein the computer readable instructions that, when executed by the processor, cause the data processing system to perform receiving the check-in operation by:
displaying a check-in editing interface, wherein the check-in editing interface comprises at least one of a text editing area, a picture editing area, a video editing area, a check-in marker style selection area, or an event selection area; and
receiving, via the check-in editing interface, an editing operation on the first social information,
wherein the first social information comprises at least one of a text, a picture, a video, a check-in marker style, or data associated with the first event.
